(19) United States
(12) Patent Application Publication
(10) Pub. No.: US 2026/0133731 A1
(43) Pub. Date: May 14, 2026

(54) STORAGE MEDIUM STORING APPLICATION PROGRAM, CONTROL METHOD, AND INFORMATION PROCESSING APPARATUS

(71) Applicant: CANON KABUSHIKI KAISHA, Tokyo (JP)

(72) Inventor: AKIHIRO YASUDA, Saitama (JP)

(21) Appl. No.: 19/376,119

(22) Filed: Oct. 31, 2025

(30) Foreign Application Priority Data
Nov. 12, 2024 (JP) 2024-197635

(51) Int. Cl. G06F 3/12

(52) U.S. Cl. CPC G06F 3/1243; G06F 3/1205; G06F 3/1225

(57) ABSTRACT

A non-transitory computer-readable storage medium storing an application program which causes an information processing apparatus to perform a control method, the application program cooperating with an Internet Printing Protocol (IPP) class driver, the control method includes displaying a control item configured to set a setting value related to booklet printing, outputting, in a case where the booklet printing is set to be performed using the control item, an instruction to perform the booklet printing to a printer designated as a transmission destination of print data, and determining, based on the setting value set using the control item, whether layout processing for the booklet printing is to be performed by the information processing apparatus or by the printer designated as the transmission destination of the print data.

### BACKGROUND

### Field of the Technology

The present disclosure relates to an extension file and an application for improving convenience for standard drivers that are compatible with any printer model.

### Description of the Related Art

Conventionally, drivers provided by printer vendors (printer manufacturers) have been used for printing. In recent years, standard drivers provided by operating system (OS) manufacturers (suppliers) are being used to enable printing without using drivers provided by printer vendors.

For example, Windows (registered trademark) includes a standard driver called Internet Printing Protocol (IPP) class driver. Android (registered trademark) includes a standard driver called Mopria (registered trademark). iOS (registered trademark) includes a standard driver called AirPrint (registered trademark) as one of the OS functions.

These standard drivers are configured to transmit print commands compliant with a printing protocol called IPP. Printers that support IPP-compliant printing can receive such print commands and perform printing. The standard drivers are characterized by their ability to support multiple models of IPP-compatible printers various printer vendors. In other words, the standard drivers are compatible with a plurality of printer models.

However, standard drivers are generally unable to process or utilize custom functions provided by printer vendors.

Japanese Patent Laid-Open No. 2023-182730 describes a method for an information processing apparatus that can communicate with printers, the method being intended for a driver installed on the information processing apparatus to use vendor's custom functions. Japanese Patent Laid-Open No. 2023-182730 describes a method for implementing vendor's custom functions by registering functions available on a printer as presets with the printer in advance and having the driver specify the presets.

This, however, may require users or administrators to pre-register desired functions with each printer. Moreover, use of custom functions including a plurality of setting items, such as booklet printing with an opening direction, fold settings, and staple settings, requires complex registration, which is burdensome to users and administrators.

### SUMMARY

According to an aspect of the present disclosure, a non-transitory computer-readable storage medium storing an application program which causes an information processing apparatus to perform a control method, the application program cooperating with an Internet Printing Protocol (IPP) class driver, the control method includes displaying a control item configured to set a setting value related to booklet printing, outputting, in a case where the booklet printing is set to be performed using the control item, an instruction to perform the booklet printing to a printer designated as a transmission destination of print data, and determining, based on the setting value set using the control item, whether layout processing for the booklet printing is to be performed by the information processing apparatus or by the printer designated as the transmission destination of the print data.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a printing system according to a first embodiment.

FIGS. 2A to 2D is a diagram illustrating an example of a hardware configuration according to the present embodiment.

FIG. 3 is a sequence diagram illustrating an example of installation processing of a print setting extension application according to the present embodiment.

FIG. 4 is a diagram illustrating an example of a search screen of an operating system (OS).

FIG. 5 is a diagram illustrating an example of query and response of capability information.

FIGS. 6A, 6B1, and 6B2 are diagrams illustrating examples of device capability information.

FIG. 7 is a diagram illustrating an example of an extended setup information file.

FIG. 8 is a sequence diagram illustrating an example of booklet printing processing according to the present embodiment.

FIGS. 9A to 9C are diagrams illustrating examples of user interfaces (UIs) of a standard driver.

FIGS. 10A and 10B are diagrams illustrating examples of UIs of the print setting extension application.

FIG. 11 is a diagram illustrating an example of a print setting screen displayed by the OS.

FIGS. 12A and 12B are a sequence diagram illustrating an example of booklet printing imposition processing according to the present embodiment.

### DESCRIPTION OF THE EMBODIMENTS

Embodiments of the present disclosure will be described below with reference to the drawings.

### <First Embodiment>

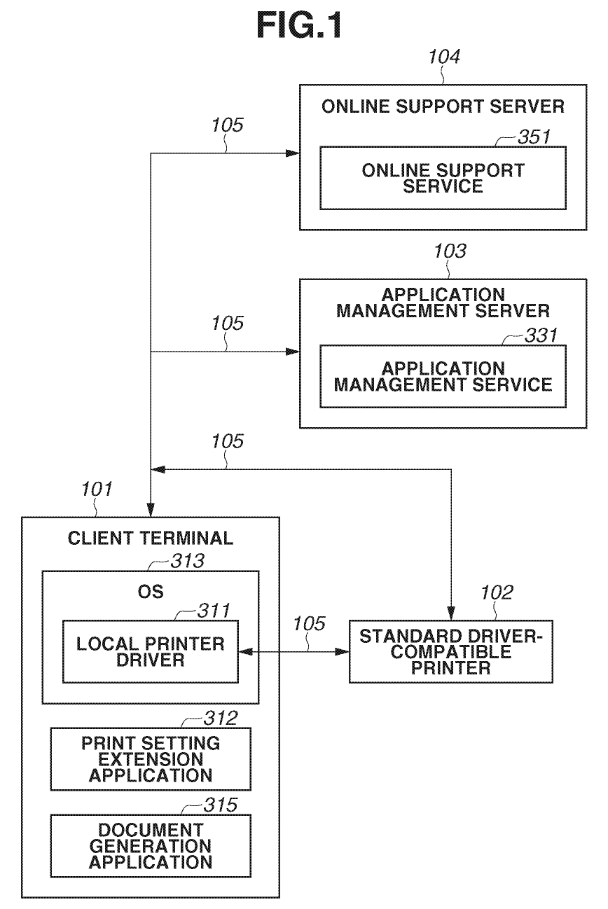

FIG. 1 is a configuration diagram of a printing system according to the present embodiment. A client terminal 101, a standard driver-compatible printer 102, an application management server 103, and an online support server 104 are connected via a network 105.

While FIG. 1 illustrates one client terminal 101 and one standard driver-compatible printer 102, there may be more than one client terminal 101 and more than one standard driver-compatible printer 102.

Similarly, the application management server 103 and the online support server 104 may be server systems including a plurality of information processing apparatuses. Configuring each server as a server system including a plurality of information processing apparatuses enables load distribution among the plurality of information processing apparatuses.

The application management server 103 and the online support server 104 may be virtually configured within a single physical information processing apparatus.

The network 105 may include connections to cloud services or wide area networks (WANs) such as the Internet. The entire network 105 may be a closed environment such as a corporate local area network (LAN).

The client terminal 101 is an information processing apparatus such as a personal computer (PC), a tablet, and a smartphone, i.e., a terminal to be directly operated by a user. Various pieces of application software can be run on the client terminal 101.

A document generation application 315 is an application that is bundled with an operating system (OS) 313 or can be used through subsequent installation. The user can generate documents using the document generation application 315 and instruct the standard driver-compatible printer 102 to print by using functions of the OS 313 (including a standard driver).

A local printer driver 311 is software provided by the provider (supplier, manufacturer) of the OS 313 built in the client terminal 101, and a driver different from ones provided by printer manufacturers. The local printer driver 311 can transmit print data to a plurality of different printers provided by a plurality of different manufacturers.

The local printer driver 311 may be constituted by one or more modules included in the OS 313. As employed herein, the operations of the local printer driver 311 and the OS 313 may be described collectively with the OS 313 as the operating entity. Pieces of printing-related software included in the OS 313 may be referred to as printing software.

Examples of the local printer driver 311 include an Internet Printing Protocol (IPP) class driver included in Windows (registered trademark). Print data generated by the IPP class driver is based on the IPP, and any printer that supports IPP-compliant printing can receive the print data. The local printer driver 311 may be referred to as a standard driver, a generic driver, etc.

A print setting extension application 312 is an application program for assisting (supporting) the local printer driver 311. The print setting extension application 312 can also extend print setting functions of print data to be transmitted to printers associated with the local printer driver 311, as well as job layout.

The standard driver-compatible printer 102 is a device that actually performs printing on recording media such as sheets of paper, and is an image forming apparatus that converts print data received via the network 105 into image data and prints the image data. The standard driver-compatible printer 102 is a printer that supports printing using standard printers such as the IPP class driver.

The standard driver-compatible printer 102 can communicate with a cloud print server (not illustrated), and is further connected to the same closed network as is the client terminal 101. The standard driver-compatible printer 102 can thus receive print data from the client terminal 101 via the cloud print server, and can directly receive print data from the client terminal 101 without the intermediary of the cloud print server.

The standard driver-compatible printer 102 receives print data generated by the local printer driver 311 on the client terminal 101.

The application management server 103 stores and manages various applications. The application management server 103 receives identification information about an application and a download request from the client terminal 101, and transmits the application identified based on the received identification information to the client terminal 101.

The online support server 104 is a server apparatus that provides an online support service 351. The online support service 351 is a service for providing files describing information for extending the functions of the client terminal 101 to the client terminal 101.

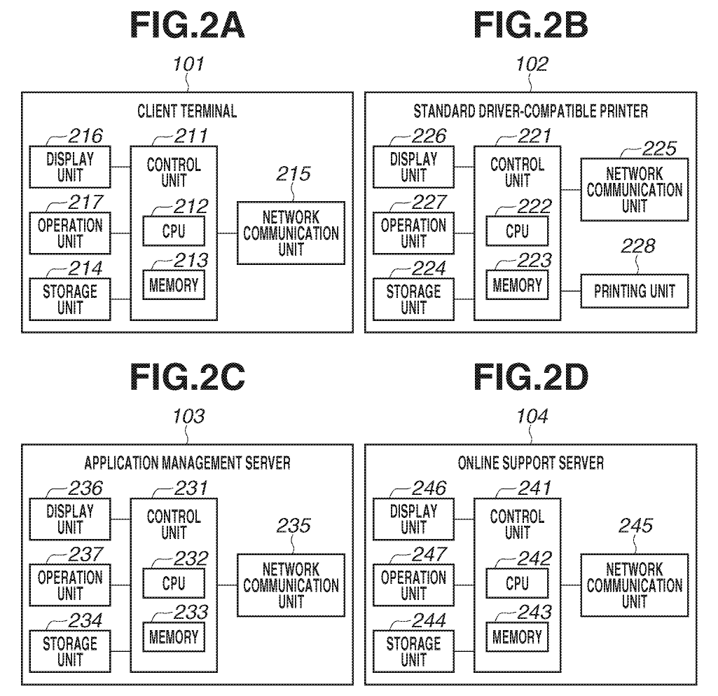

Next, a hardware configuration of the printing system according to the present embodiment will be described with reference to FIG. 2.

FIG. 2A is a block diagram illustrating a hardware configuration of the client terminal 101.

The client terminal 101 includes a display unit 216, an operation unit 217, a storage unit 214, a control unit 211, and a network communication unit 215.

The storage unit 214 refers to a nonvolatile storage device such as a hard disk and a solid-state drive (SSD), and is capable of storing and rewriting digital data.

The control unit 211 includes a central processing unit (CPU) 212 and a memory 213, and controls operation of the entire client terminal 101. The CPU 212 loads programs stored in the storage unit 214 into the memory 213 and executes the programs. The memory 213 is a main storage memory of the CPU 212, and used as a work area and a temporary storage area for loading various programs.

The network communication unit 215 is a device that communicates with the external network 105. The network communication unit 215 inputs and outputs digital data from/to external servers, client terminals, and the like via the network 105.

The display unit 216 is a device for displaying visual information to the user in real time, such as a liquid crystal display. The operation unit 217 is a device for accepting

input from the user via a keyboard, mouse, and the like. A device having the functions of both the display unit 216 and the operation unit 217, such as a touchscreen, may be used.

FIG. 2B is a block diagram illustrating a hardware configuration of the standard driver-compatible printer 102. The standard driver-compatible printer 102 includes a display unit 226, an operation unit 227, a storage unit 224, a control unit 221, a network communication unit 225, and a printing unit 228.

The display unit 226 is a device for displaying information to the user in real time. Examples include a touchscreen and light-emitting diodes (LEDs) installed in the standard driver-compatible printer 102.

The operation unit 247 is a device for accepting input from the user. Aside from a touchscreen, hardware keys such as a numerical keypad may be included. The storage unit 224 and the control unit 221 are similar to those of the client terminal 101, and a description thereof will thus be omitted.

The network communication unit 225 is a device that communicates with the external network 105, and mainly has the role of receiving print data and transmitting the status of the standard driver-compatible printer 102, such as errors, to external servers and the like.

The printing unit 228 is a device that performs print processing through a series of operations including sheet feeding, printing, and sheet discharge on sheets prepared in cassettes or on trays. The printing method is not limited to electrophotography or inkjetting in particular. A two-sided unit used in discharging sheets and finishing devices for stapling, punching, and the like are also included in the printing unit 228.

While in the present embodiment a single-function printer that performs only a print function is described as an example of the standard driver-compatible printer 102, a multifunction printer (multifunction peripheral) having a scanner function and a facsimile (FAX) function as well may be used.

FIG. 2C is a hardware block diagram illustrating details of the application management server 103. In the present embodiment, the application management server 103 is described to be constituted by a single information processing apparatus, but may be constituted by a plurality of information processing apparatuses.

The application management server 103 includes a display unit 256, an operation unit 257, a storage unit 254, a control unit 251, and a network communication unit 255. The display unit 256 and the operation unit 257 are similar to the display unit 216 and the operation unit 217 of the client terminal 101, and a description thereof will thus be omitted. The storage unit 254 is a memory device such as a hard disk drive (HDD) and an SSD. The storage unit 254 stores files describing information for extending functions provided by the client terminal 101.

The control unit 251 includes a CPU 252 and a memory 253. The CPU 252 controls operation of the entire application management server 103. The memory 253 is used for processing performed by the CPU 252. The network communication unit 255 is an interface for the application management server 103 to communicate with the client terminal 101. The application management server 103 receives acquisition requests for files stored in the storage unit 254 and transmits corresponding files to the client terminal 101 via the network communication unit 255.

FIG. 2D is a hardware block diagram illustrating details of the online support server 104. In the present embodiment, the online support server 104 is described to be constituted by a single information processing apparatus, but may be constituted by a plurality of information processing apparatuses.

The online support server 104 includes a display unit 246, an operation unit 247, a storage unit 244, a control unit 241, and a network communication unit 245. The display unit 246 and the operation unit 247 are similar to the display unit 216 and the operation unit 217 of the client terminal 101, and a description thereof will thus be omitted. The storage unit 244 is a memory device such as an HDD and an SSD. The storage unit 244 stores extended setup information files that are files describing information for extending functions provided by the client terminal 101.

The control unit 241 includes a CPU 242 and a memory 243. The CPU 242 controls operation of the entire online support server 104. The memory 243 is used for processing performed by the CPU 242. The network communication unit 245 is an interface for the online support server 104 to communicate with the client terminal 101. The online support server 104 receives acquisition requests for files stored in the storage unit 244 and transmits corresponding files to the client terminal 101 via the network communication unit 245.

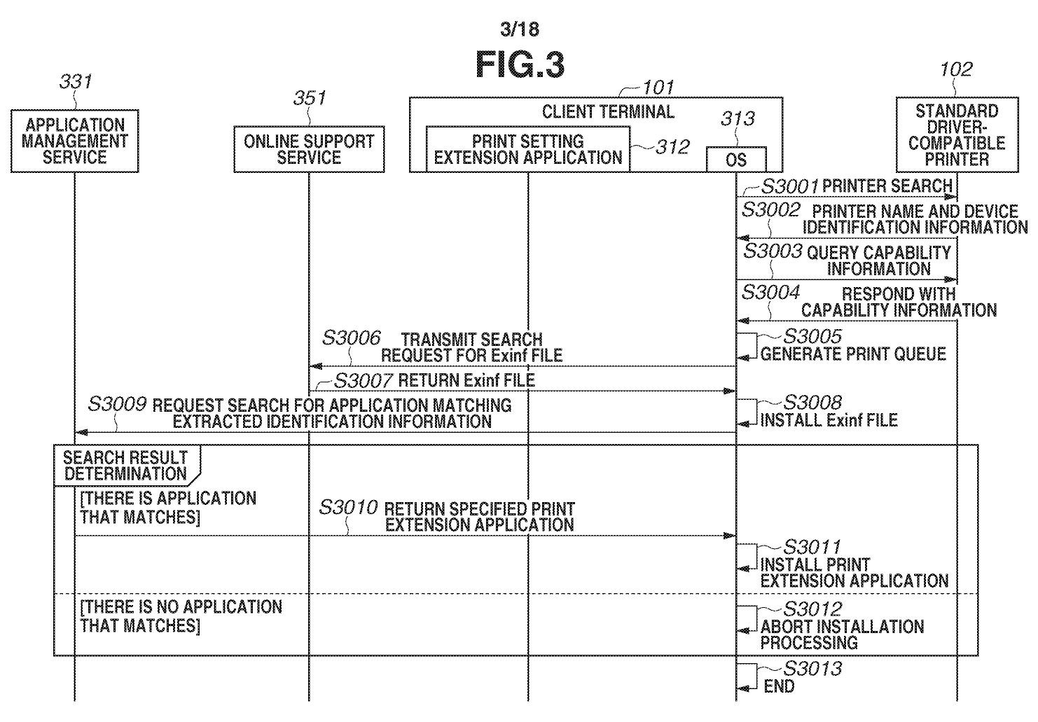

Next, an example of the user's operation procedure and a sequence between the pieces of software and print services according to the present embodiment will be described with reference to FIG. 3. Here, a procedure from when the standard driver-compatible printer 102 connects to the local network (network 105) and is connected to the OS 313 on the client terminal 101 through the network 105 to when the print setting extension application 312 is subsequently downloaded and installed will be described.

In step S3001, the OS 313 of the client terminal 101 initially searches the local network 105 for printers compatible with printing using standard drivers. For example, in Windows, the search uses multicast Domain Name System (mDNS) to query the entire local network 105 whether standard drivers are supported.

In step S3002, the standard driver-compatible printer 102 transmits its printer name as well as device identification information about the standard driver-compatible printer 102 in response to the search by the OS 313 on the client terminal 101. The device identification information may be a hardware identifier (ID) (HWID) for identifying a model or a compatible ID (COID) indicating a group of multiple models, for example.

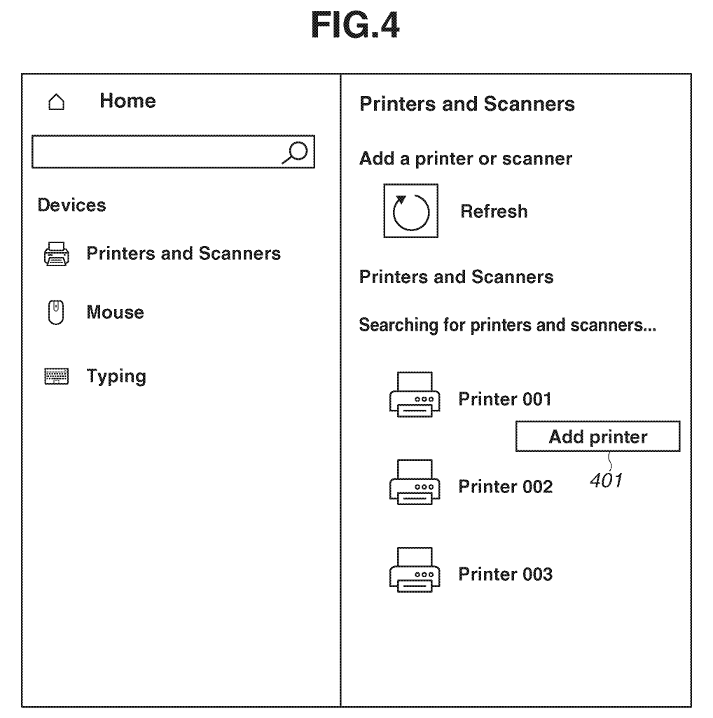

The OS 313 displays a printer list on the client terminal 101 based on the acquired printer information and printer information detected by the search of the network 105. FIG. 4 is a diagram illustrating an example of a printer list screen that the OS 313 displays on the client terminal 101.

Next, the user selects the printer information about the printer they wish to register with the client terminal 101 from the displayed printers. For selection, the user can press an "Add printer" control 401 to create a queue for the printer they wish to use in the OS 313.

In step S3003, the OS 313 queries capability information about the selected standard driver-compatible printer 102. Which pieces of capability information (functions, setting items) to query is determined by the OS 313.

In step S3004, the standard driver-compatible printer 102 responds to the OS 313 with the capability information about the standard driver-compatible printer 102. The standard driver-compatible printer 102 does not respond to the OS 313 if no response attribute corresponding to the attributes queried by the OS 313 of the client terminal 101 is stored.

Next, the OS 313 starts linking the local printer driver 311 with the queue based on the device identification information and printer name of the printer selected by the user. In step S3005, the OS 313 generates a print queue for the local printer driver 311 with basic device capability information specified by the OS 313.

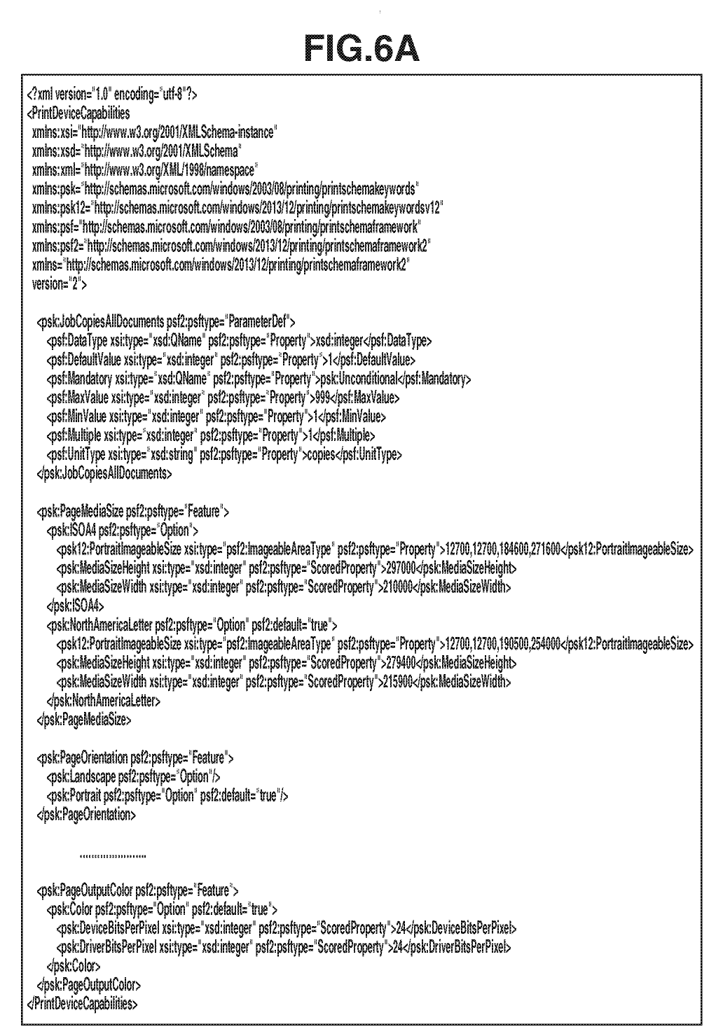

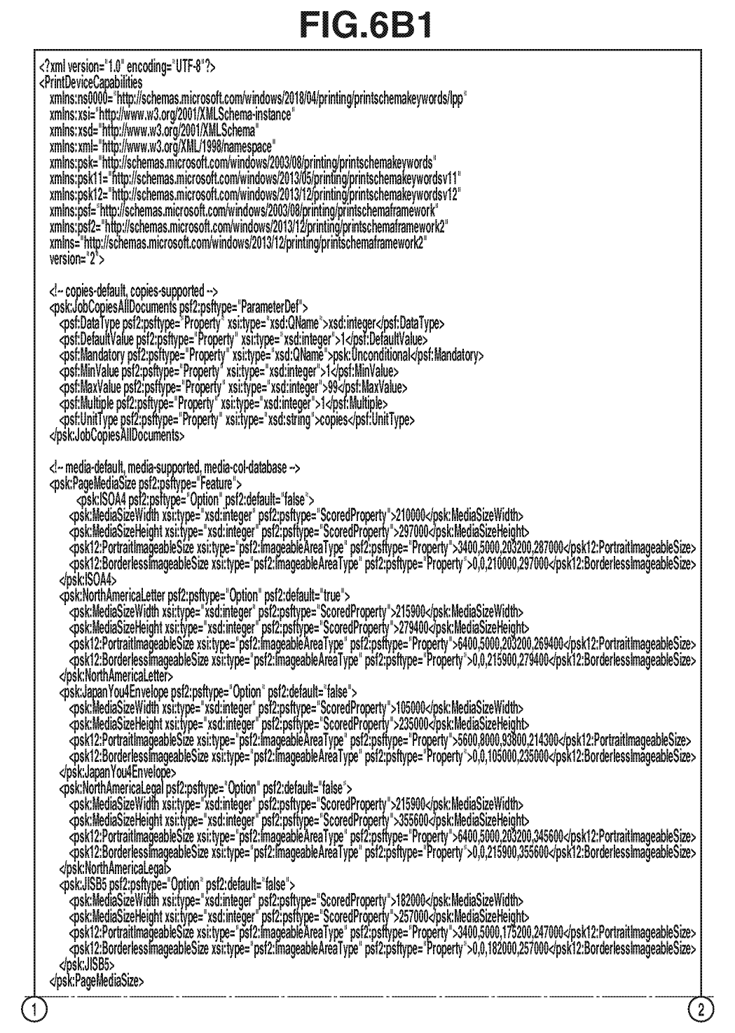

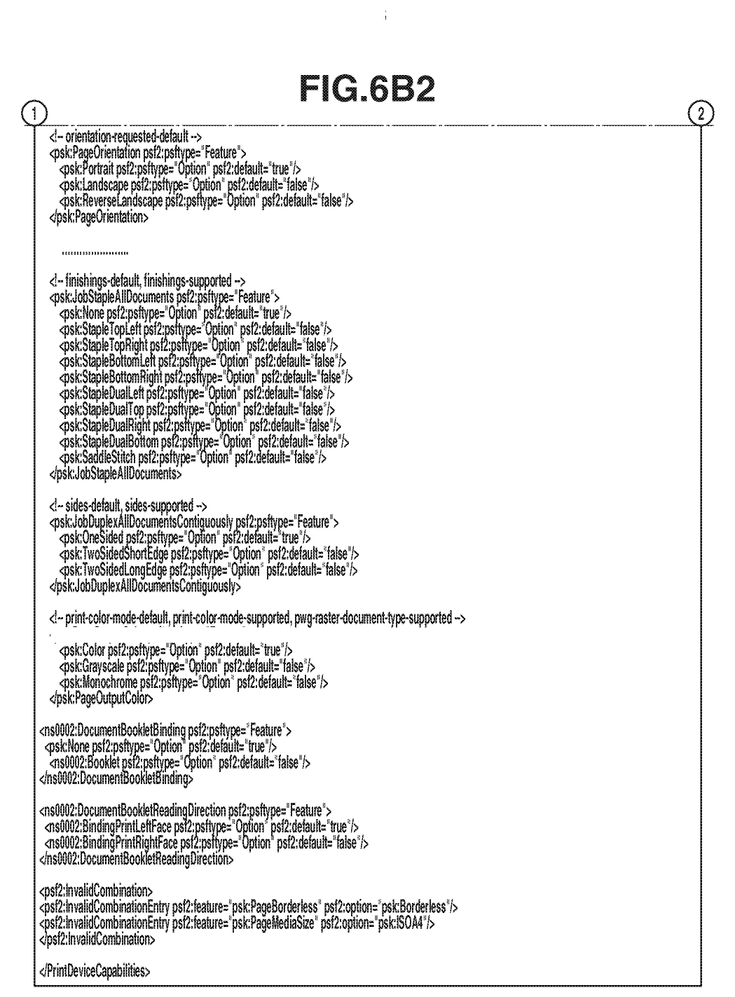

Device capability information refers to definition information needed to generate print setting capability information about a printer driver. Examples include definition information described in Extensible Markup Language (XML), like PrintDeviceCapabilities (PDC). FIG. 6A is a diagram illustrating an example of device capability information bundled with the OS 313. For example, "PageMediaSize" representing paper size, which is described in "Feature" representing a function, has only two capabilities "A4" and "LETTER", which are described in "Option" representing options. This information is linked with the print queue and managed by the OS 313.

In step S3005, in addition to the generation of the print queue, the OS 313 updates the device capability information constituting the local printer driver 311 with the acquired capability information. FIGS. 6B1 and 6B2 are a diagram illustrating an example of the device capability information updated with the capability information acquired from the standard driver-compatible printer 102. For example, "Options" other than "A4" and "LETTER" are added, as paper sizes that the standard driver-compatible printer 102 can print, to "PageMediaSize" representing paper size.

At this phase, information about "DocumentBookletBinding" and "DocumentBookletReadingDirection" does not need to be added.

The process of linking the local printer driver 311 with the queue is thereby completed. Through the processing so far, the client terminal 101 becomes capable of transmitting print data to the standard driver-compatible printer 102 using the print queue for the standard driver-compatible printer 102.

Next, the OS 313 starts installation processing of an extended setup information file that is linked with the standard driver-compatible printer 102 and extends the local printer driver 311.

The OS 313 initially performs additional identification information attachment processing on the device identification information. This processing is needed in acquiring an extended setup information file (hereinafter, may be referred to as an Exinf file) 700 from the online support server 104. Additional identification information may be any character string different from normal device identification information.

In the present embodiment, for the sake of distinction from applications of other devices, the OS 313 attaches additional identification information indicating printer-related applications ("PrinterApp_") to the device identification information. Note that "PrinterApp_" is merely an example, and other character strings, numbers, or symbols may be used. For example, if the device identification information about the standard driver-compatible printer 102 is device001, the device identification information resulting from the foregoing additional identification information attachment processing is PrinterApp_device001.

In step S3006, the OS 313 transmits a search request for an extended setup information file 700 including the target device identification information accompanied by the additional identification information to the online support service 351. In step S3006, the online support service 351 is notified of "PrinterApp_device001" with the additional identification information attached.

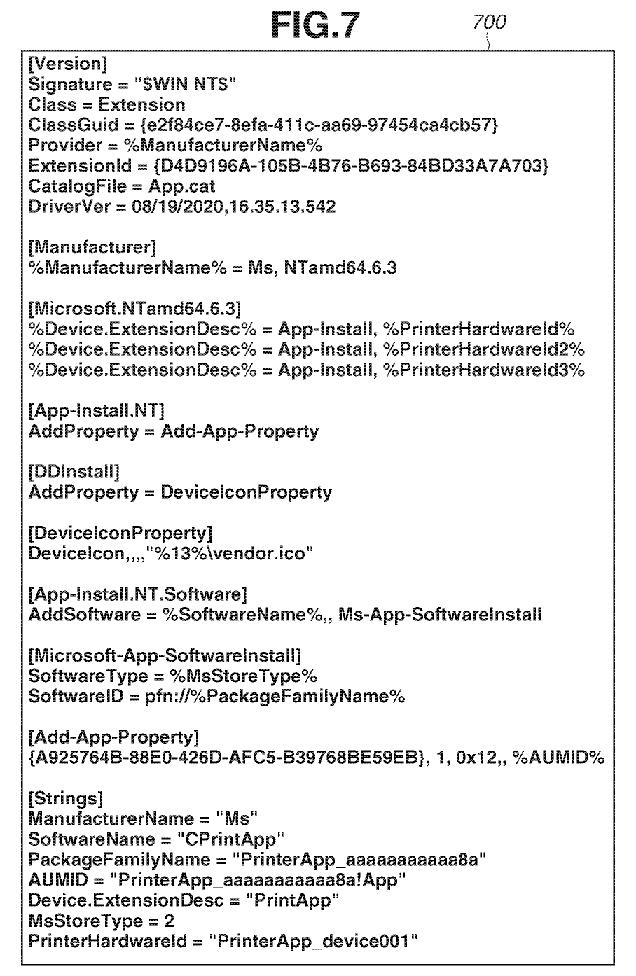

The online support service 351 stores the extended setup information file illustrated in FIG. 7. FIG. 7 illustrates an example of the extended setup information file 700. The extended setup information file 700 is a file created by the manufacturer (vendor) of the standard driver-compatible printer 102 and registered with the online support service 351.

In the present embodiment, the extended setup information file 700 is prepared for each printer model. In fact, a single extended setup information file 700 may describe device identification information accompanied by additional identification information for a plurality of models.

The extended setup information file 700 describes an application identifier for identifying the print setting extension application 312 that is used to configure print data to be transmitted to the standard driver-compatible printer 102. In the extended setup information file 700 illustrated in FIG. 7, "PackageFamilyName" is the identification information about the print setting extension application 312. "PrinterHardwareID" describes the character string obtained by adding the additional identification information to the identification information about the standard driver-compatible printer 102.

The online support service 351 thus stores the extended setup information file that describes the identifier of the print setting extension application 312 and the character string obtained by adding the additional identification information to the identification information about the standard driver-compatible printer 102. To acquire the needed extended setup information file 700 as appropriate, the OS 313 attaches the additional identification information to the device identification information, and acquires the extended setup information file 700 from the online support service 351.

Receiving the search request, the online support service 351 identifies the extended setup information file that matches the device identification information accompanied by the additional identification information, specified by the request.

As a result of the search, if the extended setup information file 700 including the target device identification information is stored in the online support service 351, then in step S3007, the online support service 351 returns the extended setup information file 700 to the OS 313. In step S3008, the content of the extended setup information file 700 is written to the registry of the OS 313, whereby the extended setup information file 700 is installed in the OS 313.

Next, the OS 313 extracts identification information about the print setting extension application 312 from the extended setup information file 700 installed. The identification information about the print setting extension application 312 refers to the identifier defined by "PackageFamilyName" in the extended setup information file 700. The above is the processing when the extended setup information file 700 corresponding to the standard driver-compatible printer 102 is stored in the online support service 351.

Identification information about the print setting extension application 312 described in an Exinf file corresponding to inkjet printers and identification information about the print setting extension application 312 described in an Exinf file corresponding to electrophotographic printers may be the same. In such a case, the same print setting extension application 312 is installed in generating print queues based on the information about the inkjet printers and in generating print queues based on the information about the electrophotographic printers.

There may be cases where the online support service 351 is unable to detect the extended setup information file 700 including the target device identification information as a result of the search. In such a case, the OS 313 completes the queue generation and aborts the installation processing of the print setting extension application 312. The OS 313 also aborts the installation processing if the extended setup information file 700 fails to be received within a predetermined time from the search request in step S3006, or if an error notification is received from the online support service 351.

In the present embodiment, the Exinf file 700 is registered with the online support service 351 for each printer model. However, a single Exinf file 700 describing identification information about a plurality of standard driver-compatible printers 102 may be prepared.

Suppose, for example, that an Exinf file 700 describing both identification information about a standard driver-compatible printer 102 that is an inkjet printer and identification information about a standard driver-compatible printer 102 that is an electrophotographic printer is registered in the online support service 351. This enables installation of the same print setting extension application 312 when generating print queues, whether for the inkjet printer or for the electrophotographic printer.

From step S3009 onward, processing when the extended setup information file 700 is successfully acquired and the identification information about the print setting extension application 312 is successfully extracted will be described.

In step S3009, the OS 313 requests the application management service 331 to search for an application matching the extracted identification information about the print setting extension application 312.

The application management service 331 stores the print setting extension application 312 to be run on the client terminal 101 in association with the identification information about the print setting extension application 312. The print setting extension application 312 and the identification information about the print setting extension application 312 are registered with the application management service 331 by the vendor who provides the standard driver-compatible printer 102.

If there is a print setting extension application 312 stored in the application management service 331 that matches the identification information about the requested print setting extension application 312, then in step S3010, the application management service 331 returns the print setting extension application 312 to the OS 313. The print setting extension application 312 returned here is an application to which the same ID as the transmitted identification information about the print setting extension application 312 is attached.

In step S3011, the OS 313 installs the acquired print setting extension application 312 in association with the print queue generated in step S3005. The OS 313 stores the identification information about the print setting extension application 312 in the registry as information about the print queue. The print setting extension application 312 configures settings in the OS 313 so that the print queue linked with this application issues event notifications to the OS 313 at timing set on a print setting screen.

The installed print setting extension application 312 is launched after the client terminal 101 is powered on and the OS 313 starts up. After launched, the print setting extension application 312 may run as a background task.

If there is no print setting extension application 312 stored in the application management service 331 that matches the identification information about the requested print setting extension application 312, then in step S3012, the OS 313 aborts the installation processing of the print setting extension application 312. In such a case, the generated print queue and the local printer driver 311 are installed in association with each other, and the processing ends without linking the print setting extension application 312 with the print queue.

In the foregoing description, the extended setup information file 700 is searched for by adding a predetermined character string to the device identification information about the standard driver-compatible printer 102. However, the search may be configured to be performed without adding a predetermined character string as long as the installation file of the printer driver can be identified.

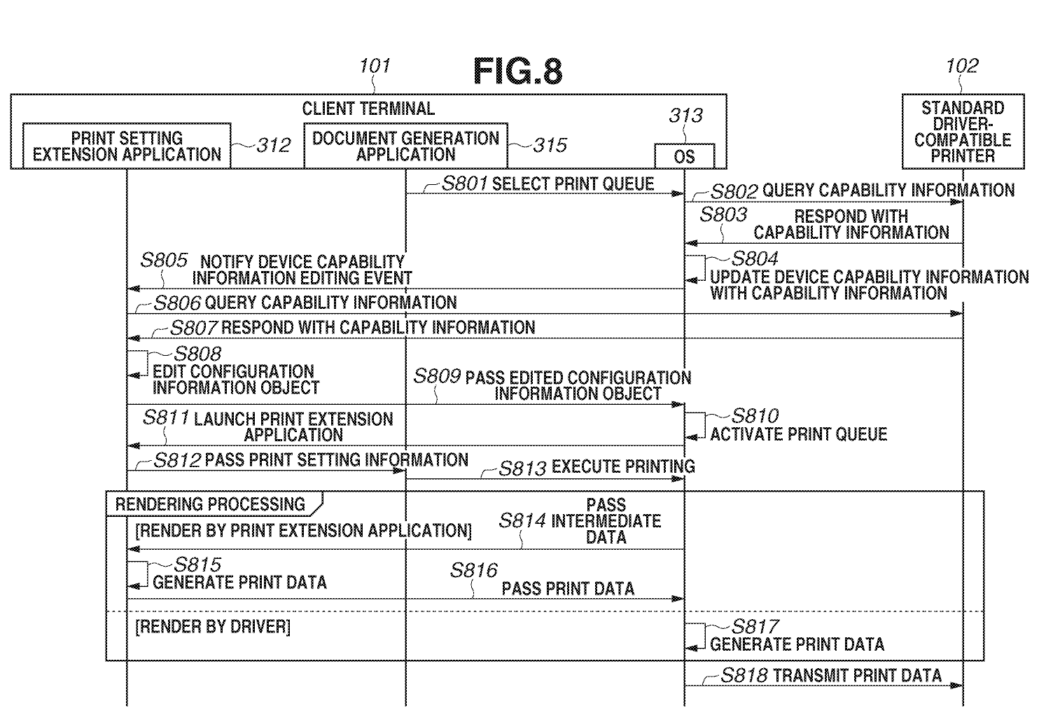

Next, an example of the user's procedure and a sequence between the pieces of software, the client terminal 101, and the standard driver-compatible printer 102 will be described with reference to FIG. 8.

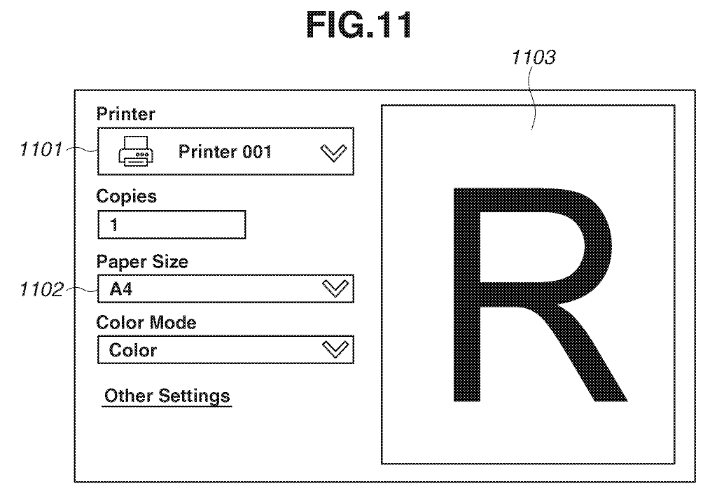

Before entering the sequence, the document generation application 315 initially requests the OS 313 to display a print setting initial screen in response to the user's pressing of a print setting button. The OS 313 displays the print setting screen illustrated in FIG. 11 as the print setting initial screen.

While in the present embodiment the OS 313 displays the print setting initial screen, the document generation application 315 may display similar functions. The print setting initial screen may include a user interface (UI) 1101 for selecting print queues, various print setting UIs 1102, and a print preview 1103. In step S801, the OS 313 receives the user's selection of a printing apparatus via UI 1101 to be the transmission destination of print data.

In step S802, the OS 313 queries the standard driver-compatible printer 102 selected in step S801 for the capability information about the standard driver-compatible printer 102 via the queue corresponding to the standard driver-compatible printer 102. Which pieces of capability information to query is determined by the OS 313. The capability information is similar to that described in step S3003 of FIG. 3.

For example, the query to the standard driver-compatible printer 102 is made using an IPP standard protocol such as Get-Printer-Attributes. In the case of using Get-Printer-Attributes, the capability information determined by the OS 313 is queried in a list form.

In step S803, the standard driver-compatible printer 102 responds to the OS 313 with the capability information about the standard driver-compatible printer 102 in compliance with IPP, based on the list of capability information transmitted by Get-Printer-Attributes.

Suppose, for example, that the media size attribute is specified by Get-Printer-Attributes. If the media size attribute is stored in the standard driver-compatible printer 102, the standard driver-compatible printer 102 returns the value (such as A4, B5, and Letter) linked with the attribute. If the attribute specified by Get-Printer-Attributes is not stored in the standard driver-compatible printer 102, the standard driver-compatible printer 102 does not respond with any linked value.

Default capability information supported by the standard driver-compatible printer 102 can be acquired in a list form by specifying "all" as the specification value of Get-Printer-Attributes or by specifying no value.

In step S804, the OS 313 updates the device capability information with the capability information acquired from the standard driver-compatible printer 102. The device capability information is updated by adding the capability information acquired in step S803 of FIG. 8 to the device capability information generated in step S3005 of FIG. 3.

In step S805, the OS 313 notifies the print setting extension application 312 of an event that enables editing of the device capability information (device capability information editing event). Receiving this event, the print setting extension application 312 can use an application programming interface (API) capable of editing the device capability information. To add capability information (functions, setting items) not supported by the OS 313, the capability information can be transmitted to the standard driver-compatible printer 102 using the print setting extension application 312.

In step S806, receiving the device capability information editing event from the OS 313, the print setting extension application 312 queries the capability information about the standard driver-compatible printer 102. Step S806 is an example of an acquisition process.

Here, the print setting extension application 312 may query custom capability information different from that stored in the print setting extension application 312 and queried by the OS 313. Examples of the custom capability information in the present embodiment include "booklet printing". Like step S802, the print setting extension application 312 can acquire the capability information about booklet printing using Get-Printer-Attributes. In doing so, the print setting extension application 312 specifies "booklet printing" as the capability information to query.

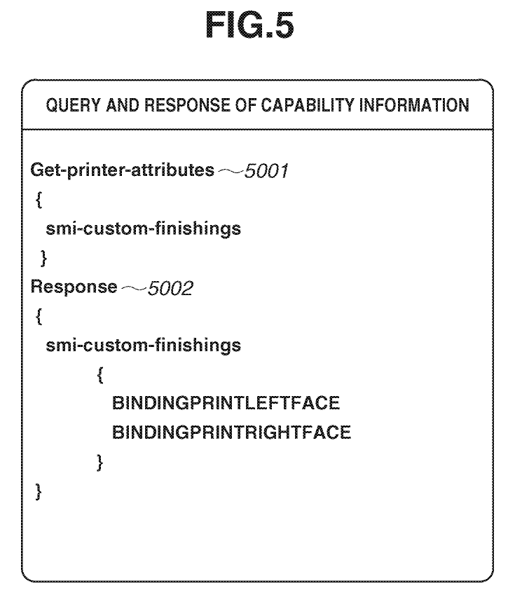

FIG. 5 illustrates an example of the query and response of capability information.

FIG. 5 illustrates an example of Get-Printer-Attributes 5001 issued when the print setting extension application 312 queries custom capability information in step S806. Here, the print setting extension application 312 specifies "smi-custom-finishings" representing booklet printing as a parameter of Get-Printer-Attributes 5001. This capability information is not included in the IPP specifications, and defined by the vendor developing the printing apparatus for the purpose of acquiring the custom finishings information.

In step S807, receiving the query by the Get-Printer-Attributes 5001 with smi-custom-finishings specified, the standard driver-compatible printer 102 returns response data 5002 to the print setting extension application 312. Information BINDINGPRINTLEFTFACE and BINDINGPRINTRIGHTFACE indicates opening directions of booklet printing as well as that the standard driver-compatible printer 102 supports booklet printing.

The standard driver-compatible printer 102 does not need to return a response corresponding to booklet printing unless smi-custom-finishings is explicitly specified by Get-Printer-Attributes. If the specified value is "all" or no value is specified, the standard driver-compatible printer 102 does not need to return capability information that is not defined by IPP, such as booklet printing, to the print setting extension application 312 or the OS 313 as the response to Get-Printer-Attributes.

Acquiring the manufacturer's custom capability information from the standard driver-compatible printer 102, the print setting extension application 312 edits the device capability information via a configuration information object. The configuration information object is a set of data groups needed to edit the device capability information. The print setting extension application 312 is not capable of directly editing the device capability information owned by the OS 313, and thus modifies the device capability information owned by the OS 313 using this configuration information object.

In step S808, the print setting extension application 312 converts the capability information acquired in step S807 of FIG. 8, such as "booklet printing", into device capability information and adds the device capability information to the configuration information object.

In step S809, the print setting extension application 312 transmits the edited configuration information object to the OS 313. Upon receiving the configuration information object from the print setting extension application 312, the OS 313 merges the device capability information owned by the OS 313 with the device capability information added to the configuration information object by the print setting extension application 312, whereby the device capability information is updated as new device capability information.

In step S810, with the device capability information updated, the OS 313 activates the print queue, whereby the trigger to launch the UIs of the print setting extension application 312 is enabled.

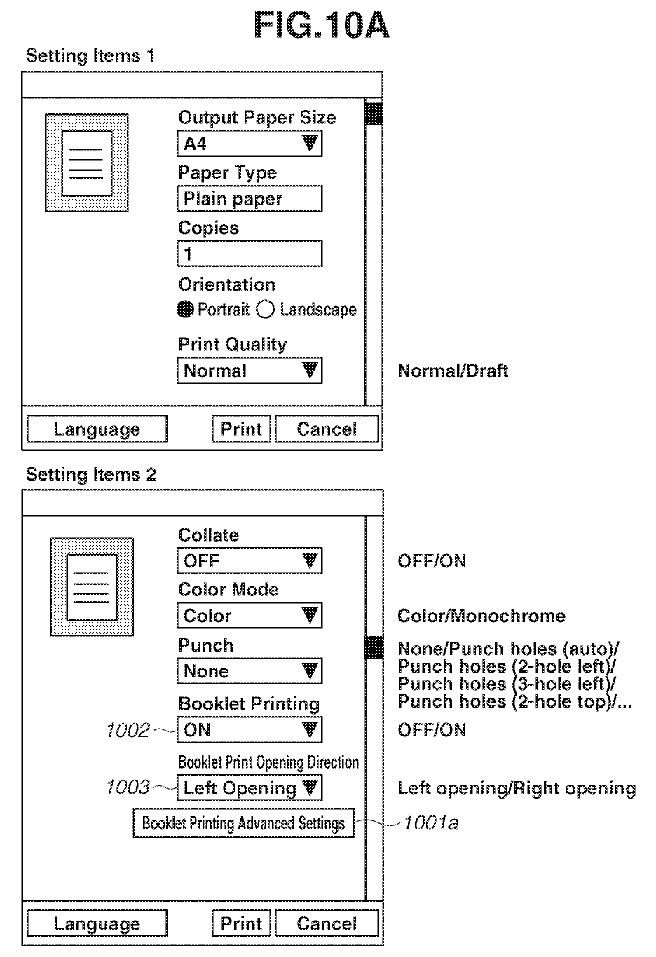

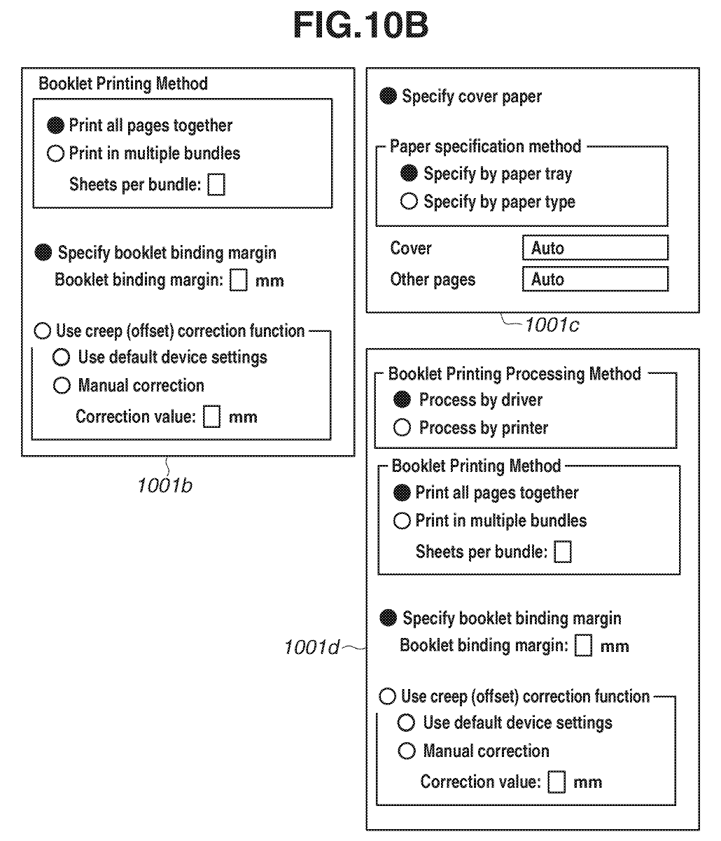

In step S811, the print setting extension application 312 is launched by the OS 313 based on user operation, and displays a print setting screen illustrated in FIG. 10A. This print setting screen does not depend on the type of document generation application 315 to use, and can display various setting items.

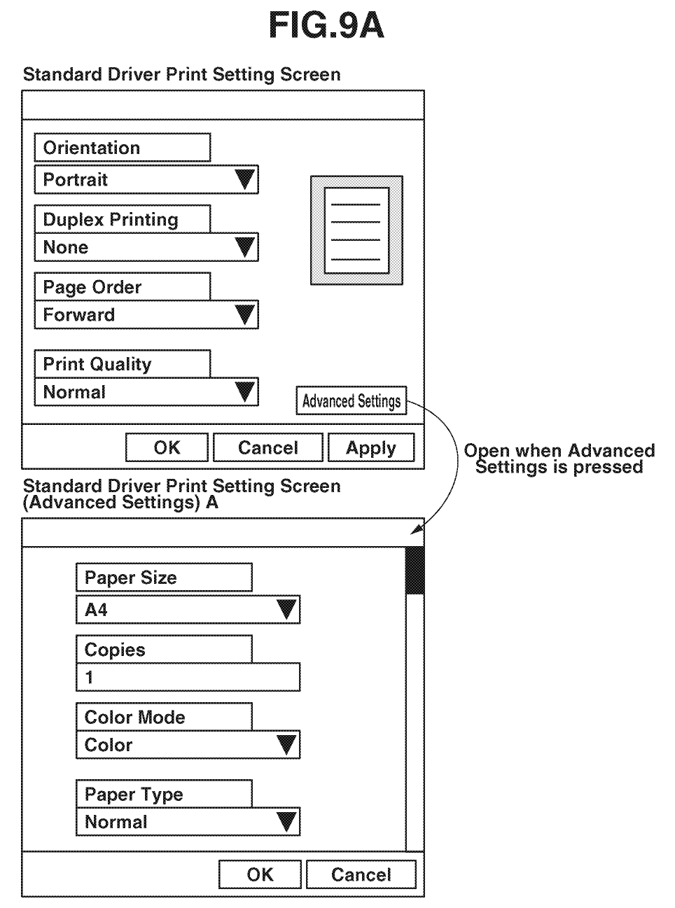

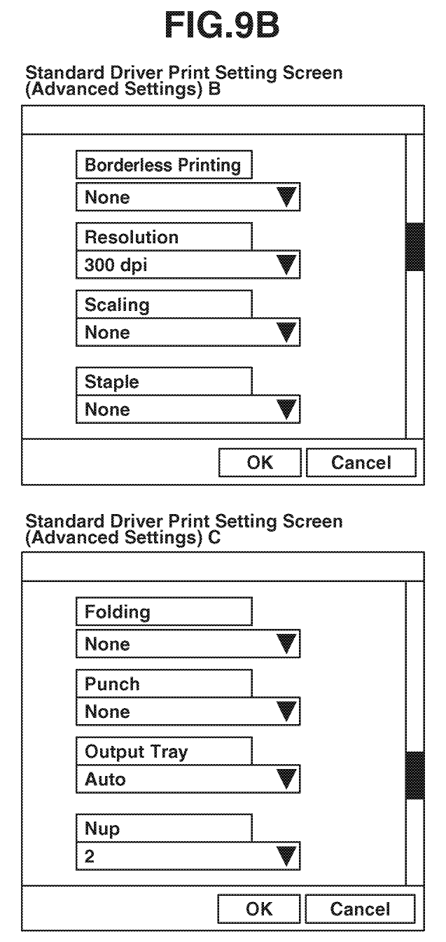

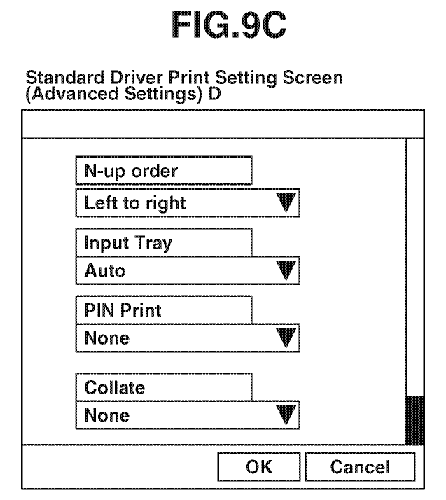

If the print setting extension application 312 is not linked with the standard driver preinstalled in the OS 313, a print setting screen provided by the standard driver is displayed as illustrated in FIGS. 9A to 9C.

On the print setting screen of the standard driver, an advanced settings button is pressed to display standard driver print setting screens (advanced settings) A to D of FIGS. 9A to 9C, whereby print settings unable to be displayed on the initial UIs of the standard driver print setting screen are displayed. The standard driver print setting screens (advanced settings) A to D may be configured to be sequentially displayed by screen scroll, for example.

The print setting extension application 312 receives print setting information generated by the OS 313 based on print setting capability information (also referred to as PrintCapabilities [PC]) generated from the device capability information, and displays the print setting information on UIs as print settings.

For example, for the output paper size in setting items 1 of FIG. 10A, the print setting extension application 312 displays print setting information generated from psk:PageMediaSize included in the print setting capability information illustrated in FIG. 6B1 and 6B2. The output paper size option, A4, is generated and displayed by the print setting extension application 312 based on print setting information "psk:ISOA4".

In such a manner, the print setting extension application 312 displays selectable items for the respective pieces of device capability information on UIs.

Custom print setting information added is also displayed in a similar manner. For example, a control item 1002 for configuring settings related to booklet printing illustrated in setting items 2 of FIG. 10A is generated from ns0002:DocumentBookletBinding in FIGS. 6B1 and 6B2. "ns0002" is a namespace indicating that names of custom setting items (or custom setting values) are defined by the manufacturer providing the standard driver-compatible printer 102 and added to the configuration information object. This setting item is intended to configure the ON/OFF setting of the booklet printing.

A control item 1003 related to a booklet print opening direction illustrated in setting items 2 of FIG. 10A is generated from ns0002:DocumentBookletReadingDirection in FIGS. 6B1 and 6B2. The options for this setting item are left opening and right opening. Left opening, which is represented by psf2:default="true" in FIGS. 6B1 and 6B2, is the default value (selected by default when the print setting screen is launched or when booklet printing ON is selected).

All setting items are generated from the capability information acquired via smi-custom-finishings. Step S811 is an example of a display process.

The print setting extension application 312 provides the function for the user to freely modify print settings, and when modifications are made, stores the setting values. Suppose, for example, that the user changes the media size from A4 to Letter on the UI. In such a case, the print setting information owned by the print setting extension application 312 changes from A4 to Letter. In the case of selecting booklet printing, the booklet printing setting is changed to ON and the option for the booklet print opening direction is selected, whereby the user can use booklet printing.

Once the user completes the print setting operation, then in step S812, the print setting extension application 312 transmits, to the OS 313, the print setting information reflecting the setting values selected within the control items of the print setting screen. The print setting information is also referred to as PrintTicket (PT). The processing on the print setting screen of the print setting extension application 312 is thereby completed.

In step S813, the OS 313 executes printing when instructed by the user via the document generation application 315.

With printing executed, the OS 313 generates intermediate data from the image data specified by the document generation application 315. In step S814, the OS 313 transmits the generated intermediate data and the print setting information to the print setting extension application 312. The intermediate data refers to data generated before conversion into print data such as page description language (PDL) data. An example is XML Paper Specification (XPS) data. The print setting information edited in step S812 may also be included in this intermediate data.

In step S815, receiving the intermediate data and the print setting information from the OS 313, the print setting extension application 312 generates print data based on the intermediate data and generates print capability information from the print setting information. The print data refers to PDL data such as a Portable Document Format (PDF) file, for example. The print capability information refers to print setting information rewritten as IPP attributes, for example.

Here, if print setting information with a custom namespace such as ns0002 added in FIGS. 6B1 and 6B2 is passed from the OS 313, the print setting extension application 312 converts the print setting information into custom print capability information and transmits the custom print capability information to the standard driver-compatible printer 102. Suppose, for example, that the print setting information of step S812 describes booklet printing = ON and the booklet print opening direction = left opening. In such a case, the print setting extension application 312 generates print capability information where a value representing BINDINGPRINTLEFTFACE is set in smi-custom-finishings.

For booklet printing, the print setting extension application 312 links one piece of print capability information in smi-custom-finishings with two pieces of setting information, or booklet printing and the booklet print opening direction, in the print setting information.

In step S816, after the generation of the print data, the print setting extension application 312 transmits the generated print data and the print capability information to the print queue of the OS 313.

In steps S814 to S816, the sequence from the acceptance of the intermediate data to the generation of the print data is performed by the print setting extension application 312. However, the print setting extension application 312 may perform only the processing for editing the intermediate data and generating the print capability information based on the print setting information, and the rendering process may be delegated to the OS 313.

The system where the local printer driver 311 generates print data instead of the print setting extension application 312 rendering the print data will be described. In step S817, the OS 313 generates XPS data serving as intermediate data, edits the page layout, and converts the XPS data into a predetermined format to generate print data. To convert the print setting information into print capability information, the OS 313 here may transmit the print data, which is the XPS data converted into a predetermined format, and the print setting information to the print setting extension application 312.

In step S818, the OS 313 transmits the print data and capability information received from the print setting extension application 312 to the standard driver-compatible printer 102 via the print queue. Through such operations, the standard driver-compatible printer 102 can be made to perform booklet printing. The process of generating the print capability information for booklet printing in step S815, transmitting the print capability information to the OS 313 in step S816, and thereby outputting the print capability information to the standard driver-compatible printer 102 is an example of an output process.

As described above, according to the first embodiment, settings related to booklet printing that are not supported by the local printer driver 311 can be configured via the print setting screen provided by the print setting extension application 312. The user can thus use the booklet printing function with simple operations compared to, for example, when presets described in Japanese Patent Laid-Open No. 2023-182730 are assumed to be used.

### <Second Embodiment>

In the first embodiment, the setting about whether to perform booklet printing and the setting about the opening direction are described to be accepted using the print setting extension application 312. A second embodiment deals with an example where other settings related to booklet printing are also accepted. Note that descriptions will be omitted of parts that perform similar processing to that in the first embodiment.

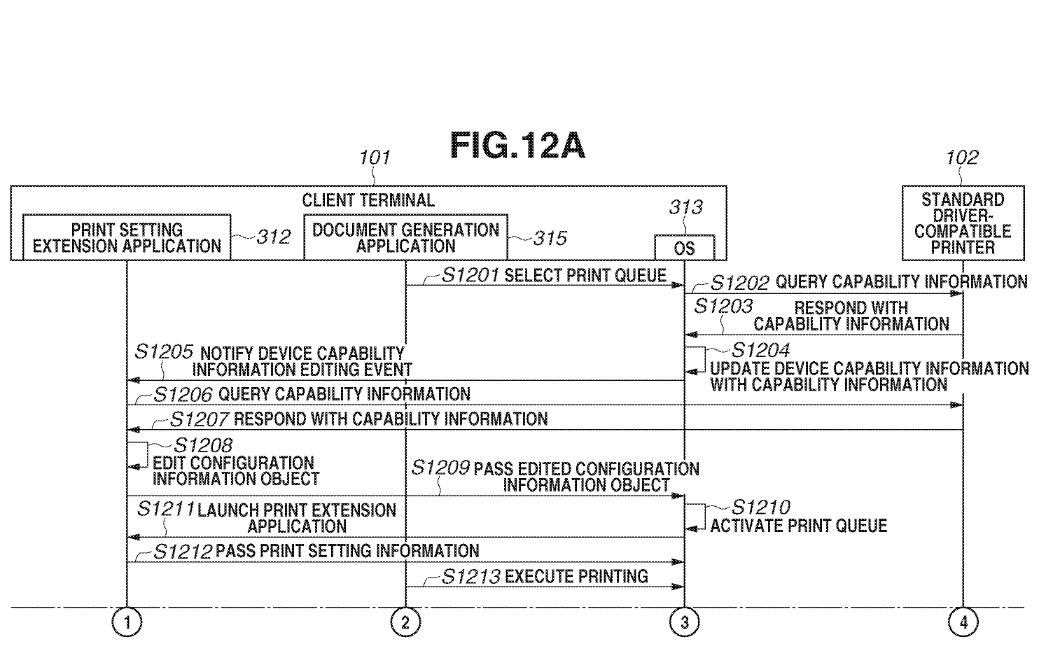

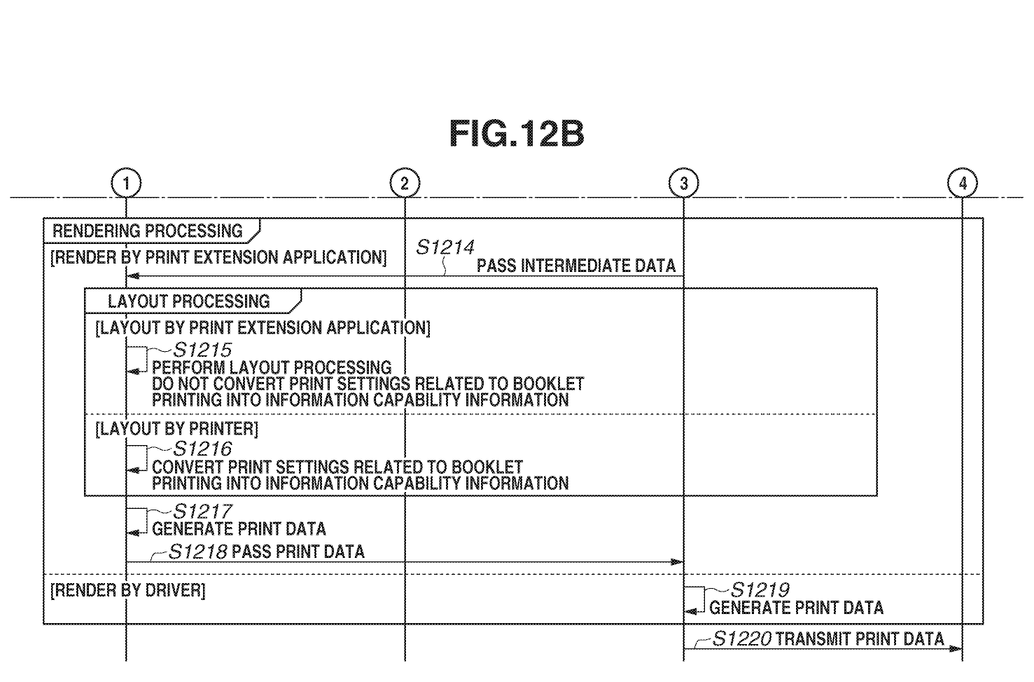

FIGS. 12A and 12B illustrate processing where whether to perform booklet printing imposition by the client (print setting extension application 312) or the device (standard driver-compatible printer 102) is switched depending on other print settings related to booklet printing. Booklet printing has items that can be additionally set when booklet printing is selected. There are cases where the booklet printing imposition processing is better performed by the print setting extension application 312 and better performed by the standard driver-compatible printer 102, depending on the settings.

The sequence from step S1201 to step S1210 of FIGS. 12A and 12B is similar to that of steps S801 to S810 in the first embodiment. A description thereof will thus be omitted.

In step S1211, the print setting extension application 312 is launched by the OS 313 based on user operation, and displays a print setting screen such as setting items 2 of FIG. 10A.

Setting items 2 include a control 1001a for configuring booklet printing advanced settings. The user can open advanced setting screens 1001b and 1001c of FIG. 10B by pressing the control 1001a. The advanced setting screens 1001b and 1001c may be configured to be sequentially displayed by scrolling or other navigation methods.

The advanced setting screens 1001b and 1001c are screens for configuring setting items associated with booklet printing. These setting items include functions to be performed by the print setting extension application 312 and functions to be performed by the standard driver-compatible printer 102.

For example, a booklet printing method (multiple volumes) and a booklet binding margin included in the advanced setting screen 1001b are functions that can be implemented by the print setting extension application 312 performing the booklet printing imposition processing and the print setting extension application 312 editing the intermediate data. A cover specification function illustrated in the advanced setting screen 1001c is also a function that can be implemented by the print setting extension application 312 performing the booklet printing imposition processing and the print setting extension application 312 editing the intermediate data.

On the other hand, a creep correction function included in the advanced setting screen 1001b is a function that is implemented by the standard driver-compatible printer 102 performing the booklet printing imposition processing and the standard driver-compatible printer 102 editing the PDL data.

The booklet printing method (split-volume printing) refers to a function of printing a document in multiple volumes if the document to be bound includes a large number of pages. For example, the user can specify the number of pages per bundle on the advanced setting screen 1001b.

The binding margin refers to a function that adds a margin to each page during booklet printing to allow proper binding. This function prevents text and images from being hidden when pages are bound, by adding margins within the respective pages. For example, the user can determine how much margin to add on the advanced setting screen 1001b.

The creep correction function is a function of performing booklet printing while correcting page offsets between outer pages and inner pages that occur during booklet binding, so that all pages can be uniformly aligned. This correction may be performed automatically by the device or manually configured by the user, as specified on the advanced setting screen 1001b.

Cover specification is a function of specifying different types of paper for the cover and inner pages. For example, the user can print the cover and inner pages by specifying feed trays or paper types on the advanced setting screen 1001c.

Such functions to be implemented by the print setting extension application 312 and those to be implemented by the standard driver-compatible printer 102 are unable to be selected in combination with each other because overlapping processing compromises output of user-intended print products. As a method for preventing such selection, for example, the print setting extension application 312 grays out the creep correction function to prevent selection if the booklet printing method, the booklet binding margin, or the cover specification function is selected. Alternatively, the print setting extension application 312 grays out the booklet printing method, the booklet binding margin, and the cover specification function to prevent selection if the creep correction function is selected.

While the conflicting relationship is indicated by graying out in this example, the display/non-display of the control items may be switched instead. Alternatively, the simultaneous selection of conflicting setting items may be avoided by marking those setting items as Invalid Combination in the device capability information via the configuration information object.

Invalid Combination indicates that two print settings as listed at the bottom of FIGS. 6B1 and 6B2 are not simultaneously selectable. In the print setting information generated from the device capability information, information indicating that selection in combination with each other is not available is attached to the combination of two print settings described here. In FIGS. 6B1 and 6B2, BORDERLESS, which represents borderless printing, and a paper size of A4 are illustrated to not be selectable in combination with each other.

The OS 313 reads this Invalid Combination information from the device capability information, and takes preventive measures so that the two pieces of print setting information marked with Invalid Combination are not selected in combination with each other.

Specifically, the print setting information about the booklet printing method, the booklet binding margin, and the cover specification function and that about the creep correction function are marked as Invalid Combination. This enables the OS 313 to prevent the user from simultaneously selecting these items when closing the UIs in step S1212. For example, the OS 313 changes the settings to resolve Invalid Combination, or issues user notifications to prompt setting changes.

Once the user completes the print setting operations of the booklet printing advanced settings, then in step S1212, the print setting extension application 312 acquires the print setting information processed within the controls of the print setting screen from the print setting screen unit, and transmits the print setting information to the OS 313. The processing on the print setting screen of the print setting extension application 312 is thereby completed.

In step S1213, the OS 313 executes printing when instructed by the user via the document generation application 315.

With printing executed, the OS 313 generates intermediate data. In step S1214, the OS 313 transmits the generated intermediate data and the print setting information edited by the print setting screen unit to the print setting extension application 312. Like the first embodiment, the intermediate data is data generated before conversion into print data such as PDL data. The print setting information edited on the print setting screen may also be included in this intermediate data.

Like the first embodiment, when receiving the intermediate data and the print setting information from the OS 313, the print setting extension application 312 generates print data based on the intermediate data and generates print capability information based on the print setting information. If the print setting information includes information related to at least one of the booklet printing method (split-volume printing)), the booklet binding margin, and the cover specification function, then in step S1215, the print setting extension application 312 performs imposition processing using a layout module included in the print setting extension application 312.

The process of determining which to perform the layout processing, the print setting extension application 312 or the standard driver-compatible printer 102, like this is an example of a determination process.

The layout module can change the layout of an XPS file transmitted from the OS 313. For example, the layout module can perform the booklet printing imposition processing employed in the present embodiment and reflect the settings of the booklet printing method (split-volume printing) and the booklet binding margin, as well as perform processing such as N-in-1 layout and insertion of stamps into images (not illustrated).

In step S1215, since the imposition processing and other booklet printing settings are processed by the layout module in the print setting extension application 312, the print setting extension application 312 does not convert the print setting information into print capability information so that redundant processing by the standard driver-compatible printer 102 is avoided.

On the other hand, if the print setting information includes information about the creep correction function, then in step S1216, the print setting extension application 312 skips the layout processing by the layout module and converts the booklet printing settings and the settings related to the creep correction function into print capability information.

If the print setting information includes none of the settings related to the booklet printing method (split-volume printing), the booklet binding margin, the cover specification function, and the creep correction function, the print setting extension application 312 may either perform the booklet printing layout or transmit the capability information about the booklet printing to the standard driver-compatible printer 102.

Like a booklet printing processing method on an advanced setting screen 1001d of FIG. 10B, the user may select which to perform booklet printing, the print setting extension application 312 or the standard driver-compatible printer 102. One of the options on the advanced setting screen 1001d reads "Process by driver", which is intended for user-friendly presentation and the booklet printing is in fact performed by the print setting extension application 312.

It will be understood that the use of the booklet printing method (split-volume printing), the booklet binding margin, the cover specification function, and the creep correction function may be restricted depending on which is selected to perform the processing, the driver or the printer.

In step S1217, the print setting extension application 312 generates print data. Like the first embodiment, if the local printer driver 313 generates print data instead of the print setting extension application 312 rendering the print data, the OS 313 may generate XPS data and convert the XPS data into a predetermined format to generate the print data.

In step S1218, the print setting extension application 312 transmits the generated print data and capability information to the OS 313.

The system where the local printer driver 313 generates print data instead of the print setting extension application 312 rendering the print data will be described. In step S1219, the OS 313 generates XPS data that is intermediate data, edits the page layout, and convert the XPS data into a predetermined format to generate print data. To convert the print setting information into capability information, the OS 313 here may transmit the print data, which the XPS data converted into the predetermined format, and the print setting information to the print setting extension application 312.

In step S1220, the OS 313 transmits the print data and capability information transmitted from the print setting extension application 312 to the standard driver-compatible printer 102 via the print queue.

Such operations enable booklet printing where whether to perform booklet printing imposition by the client (print setting extension application 312) or the device (standard driver-compatible printer 102) is switched depending on other print settings related to booklet printing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-197635, filed November 12, 2024, which is hereby incorporated by reference herein in its entirety.

What is claimed is:

1. A non-transitory computer-readable storage medium storing an application program which causes an information processing apparatus to perform a control method, the application program cooperating with an Internet Printing Protocol (IPP) class driver, the control method comprising:
displaying a control item configured to set a setting value related to booklet printing;
outputting, in a case where the booklet printing is set to be performed using the control item, an instruction to perform the booklet printing to a printer designated as a transmission destination of print data; and
determining, based on the setting value set using the control item, whether layout processing for the booklet printing is to be performed by the information processing apparatus or by the printer designated as the transmission destination of the print data.

2. The non-transitory computer-readable storage medium according to claim 1, wherein the setting value includes a first setting value corresponding to creep correction.

3. The non-transitory computer-readable storage medium according to claim 2, wherein, in a case where a setting value to perform the creep correction is set, the control method determines that the printer designated as the transmission destination of the print data is to perform the layout processing.

4. The non-transitory computer-readable storage medium according to claim 1, wherein the setting value includes at least one of a second setting value corresponding to split-volume printing, a third setting value corresponding to a binding margin, and a fourth setting value corresponding to cover specification.

5. The non-transitory computer-readable storage medium according to claim 4, wherein, in a case where at least one of the second, third, or fourth setting values is set, the control method determines that the information processing apparatus is to perform the layout processing.

6. The non-transitory computer-readable storage medium according to claim 1,
wherein the setting value includes a first setting value corresponding to creep correction, a second setting value corresponding to split-volume printing, a third setting value corresponding to a binding margin, and a fourth setting value corresponding to cover specification, and
wherein the first setting value is unable to be set in combination with any of the second, third, or fourth setting values.

7. The non-transitory computer-readable storage medium according to claim 1, wherein the control method further comprises acquiring capability information related to the booklet printing from a printer designated as the transmission destination of the print data.

8. A control method of an information processing apparatus, in which an Internet Printing Protocol (IPP) class driver and an application program are installed, the application program cooperating with the IPP Class Driver, the control method comprising:
displaying a control item configured to set a setting value related to booklet printing;
outputting, in a case where the booklet printing is set to be performed using the control item, an instruction to perform the booklet printing to a printer designated as a transmission destination of print data; and
determining, based on the setting value set using the control item, whether layout processing for the booklet printing is to be performed by the information processing apparatus or by the printer designated as the transmission destination of the print data.

9. An information processing apparatus, in which an Internet Printing Protocol (IPP) class driver and an application program are installed, the application program cooperating with the IPP class driver, the information processing apparatus comprising at least one processor operating to:
display a control item configured to set a setting value related to booklet printing;
output, in a case where the booklet printing is set to be performed using the control item, an instruction to perform the booklet printing to a printer designated as a transmission destination of print data; and
determine, based on the setting value set using the control item, whether layout processing for the booklet printing is to be performed by the information processing apparatus or by the printer designated as the transmission destination of the print data.
